(19) United States
(12) Patent Application Publication
(10) Pub. No.: US 2025/0367673 A1
(43) Pub. Date: Dec. 4, 2025

(54) JAW CRUSHER

(71) Applicant: SANDVIK LTD, Dungannon (GB)

(72) Inventors: Stuart GRAYDON, Dungannon (GB); Stuart SMYTH, Dungannon (GB)

(21) Appl. No.: 18/875,917

(22) PCT Filed: Jun. 19, 2023
(86) PCT No.: PCT/EP2023/066392

§ 371 Date: Dec. 17, 2024

(30) Foreign Application Priority Data
Jun. 21, 2022 (EP) 22180035.2

(51) Int. Cl. B02C 1/02; B02C 1/04

(52) U.S. Cl. CPC B02C 1/025; B02C 1/04; B02C 2210/02

(57) ABSTRACT

A jaw crusher and method or using the same is provided. The jaw crusher includes a crusher housing having an inlet for material to be crushed and an outlet for material that has been crushed. A moveable jaw, which has a wear plate and a stationary jaw, is provided with a second wear plate. The moveable jaw and the stationary jaw form between them a crushing chamber. The moveable jaw is coupled to an eccentric jaw crusher shaft, which causes the moveable jaw to reciprocate in an eccentric motion to crush the material between the moveable jaw and the stationary jaw. A toggle system is provided and includes a drive cylinder provided with an internally mounted sensor to measure the position of the moveable jaw relative to the stationary jaw.

### FIELD

The present invention relates to a jaw crusher comprising a movable jaw and a stationary jaw forming between them a variable crushing chamber of the jaw crusher. Material to be crushed is fed to an intake and is crushed between the moveable jaw and the stationary jaw progressively to a minimum size, which is set by means of a positioning device for positioning the moveable jaw. The present invention further relates to a method for adjusting the jaw crusher.

### BACKGROUND

Jaw crushers are utilized in many applications for crushing hard material. Such as pieces of rock and ore.

In use, the action of the moveable jaw causes the material fed to the jaw crusher to move down through a crushing chamber. Material to be crushed is fed to an intake for material to be crushed against wear plates on the moveable and stationary jaws. The crushed material leaves the jaw crusher via an outlet. The jaws are farther apart at the material intake than at the material outlet, forming a tapered crushing chamber so that the material is crushed progressively to smaller and smaller sizes as the material travels downward, until the material is small enough to escape from the material outlet at the bottom of the crushing chamber.

The jaw crusher further comprises a positioning device for positioning the movable jaw to a desired position with respect to the stationary jaw. The distance between the moveable jaw and the stationary jaw is referred to as the closed side setting (CSS), which is the shortest distance between the wear plate of the stationary jaw and the wear plate of the movable jaw.

It is desirable to be able to adjust the closed side setting (CSS) so as to change the size of product that may leave the crushing chamber via the outlet. It is known to adjust the CSS manually. This requires both machine and human intervention to ensure the required gap setting is achieved to obtain a specified final product. Although this setting can be achieved by the use of adjustable actuators, the measurement of the CSS is derived by traditional measurement methods, for example, a tape measure or a set gauge of a predefined size.

WO2015/035353 McLanahan describes a jaw crusher which has an adjustment mechanism coupled to the adjustable jaw for altering an angle of the adjustable jaw. A controller is configured to receive a measured parameter which is measured by a sensor and based at least in part on the measured parameter, the closed side setting is adjusted. Typically, the sensor measures a parameter that provides information on the condition of the jaw crusher such as, electrical resistance, oil condition, a hydraulic cylinder pressure, bearing temperature or power.

EP2868379 uses a level sensor to control the size of crushed material and the amount of material in the crushing chamber is measured to alter the crushing capacity of the crusher.

### SUMMARY

It is an object of the invention to remove the need for excessive machine downtime. It is another object of the present invention to eliminate human intervention when obtaining a CSS measurement. It is a further object of the present invention to obtain total wear values on the wear plates over time and compensate for this in the CSS position. These objects have been achieved by the invention set forth in the appended independent claims to which reference is made, further preferred embodiments and advantages being set forth in the appended dependent claims, the Items section and in the description.

In accordance with a first aspect of the invention there is provided a jaw crusher comprising:
a crusher housing having an inlet for material to be crushed, an outlet for material that has been crushed,
a moveable jaw, provided with a wear plate and a stationary jaw, provided with a second wear plate, the moveable jaw and the stationary jaw forming between them a crushing chamber, the moveable jaw being coupled to an eccentric jaw crusher shaft which causes the moveable jaw to reciprocate in an eccentric motion to crush the material between the moveable jaw and the stationary jaw, a toggle system comprising a toggle plate, a toggle beam and toggle clamping cylinders to clamp the toggle plate, wherein the toggle system further comprises a drive cylinder effective on the toggle beam for adjusting the position of the moveable jaw relative to the stationary jaw, wherein the drive cylinder is provided with an internally mounted sensor to measure the position of the moveable jaw relative to the stationary jaw. Advantageously, the present invention improves the measurement and control of the moveable jaw position.

Preferably, the drive cylinder is a hydraulic drive cylinder

Advantageously, a hydraulic drive cylinder is easy to control and easy to maintain.

Preferably, the internally mounted sensor is centrally mounted in the drive cylinder.

Advantageously, centrally mounting the sensor creates a compact design and integrates it in the drive cylinder.

Preferably, the internally mounted sensor is a magnetostrictive linear position sensor.

Advantageously, a magnetostrictive sensor is exceptionally shock resistant, waterproof, operates over a wide temperature and pressure range, provides suitable resolution and measurement length.

Preferably, the internally mounted sensor measures stroke distance of the drive cylinder. Measurement of stroke distance assists with determining the lifespan of components.

Preferably, measurement of the stroke distance provides a linear distance between the moveable jaw and the stationary jaw. Measurement of a linear distance improves measurement accuracy.

Preferably, measurement of the stroke distance provides a measure of total wear on the moveable jaw wear plate and fixed jaw wear plate. This measurement of wear allows for adjustment of the position of the moveable jaw.

Preferably, measurement of the stroke distance is constantly measured by the internally mounted sensor. Constant measurement allows for real time adjustment of the moveable jaw position and trend analysis recorded over time on a PLC.

Preferably, the drive cylinder is driven to urge the moveable jaw and hence moveable jaw wear plate into contact with the fixed jaw wear plate to calibrate the distance measured by the internally mounted sensor by obtaining a zero CSS position. Contact between the moveable jaw and the stationary jaw in order assists in a determination of wear on the liners and when liners need to be replaced or turned.

Preferably, the jaw crusher further comprises a control block further comprises a pressure sensor configured to detect contact between the moveable jaw and the stationary jaw. The pressure sensor assists with positioning of the moveable jaw with respect to the stationary jaw.

In accordance with a second aspect of the invention there is provided a method for adjusting a jaw crusher, the jaw crusher comprising:
a crusher housing having an inlet for material to be crushed, an outlet for material that has been crushed,
a moveable jaw, provided with a wear plate and a stationary jaw, provided with a second wear plate, the moveable jaw and the stationary jaw forming between them a crushing chamber, the moveable jaw being coupled to an eccentric jaw crusher shaft which causes the moveable jaw to reciprocate in an eccentric motion to crush the material between the moveable jaw and the stationary jaw a toggle system comprising a toggle plate, a toggle beam and toggle clamping cylinders connected to the toggle beam to clamp the toggle plate, wherein the toggle system further comprises a drive cylinder effective on the toggle beam for adjusting the position of the moveable jaw relative to the stationary jaw, wherein the drive cylinder is provided with an internally mounted sensor to measure the position of the moveable jaw relative to the stationary jaw, the method comprising;
moving, by means of a drive cylinder the moveable jaw into a position at or near the stationary jaw,
measuring the stroke of the drive cylinder using a sensor which is internally mounted in the drive cylinder to calculate the position of the moveable jaw relative to the stationary jaw. The present invention improves the measurement and control of the moving jaw position and hence CSS.

Preferably, measurement of the stroke distance provides a measure of total wear on the moveable jaw wear plate and fixed jaw wear plate. Measurement of stroke distance assists with determining the lifespan of components.

Preferably, measurement of the stroke distance is used to set the position of the moveable jaw with respect to the stationary jaw. This allows for accurate control of the size of the product leaving the machine.

The crusher may be configured to store values of the wear measurement and to store values of crushing hours, and to calculate a wear rate of the wear plates based on the stored values.

The crusher may be configured to calculate an estimate the lifespan of the wear plates based on the wear rate.

The crusher may comprise a programmable logic controller (PLC). Aptly, the calculations explained hereinbefore may be carried out by means of the PLC.

In any embodiment, the toggle system and in particular the CSS is controlled by the PLC.

Preferably, a pressure sensor may be configured to detect contact between the moveable jaw and the stationary jaw. The pressure sensor assists with positioning or the moveable jaw with respect to the stationary jaw.

Preferably, the drive cylinder may urge the moveable jaw and hence moveable jaw wear plate into contact with the fixed jaw wear plate to calibrate the distance measured by the internally mounted sensor by obtaining a zero CSS position.

### BRIEF DESCRIPTION OF THE DRAWINGS

The invention will be more clearly understood from the following description of an embodiment thereof, given by way of example only, with reference to the accompanying drawings, in which:

FIG. 1 is a front isometric view of a jaw crusher in accordance with the present invention;

FIG. 2 is a rear isometric view of a jaw crusher in accordance with the present invention;

FIG. 3 is an isometric view of a toggle system for use in a jaw crusher in accordance with the present invention;

FIG. 4 an isometric view of an adjustment device drive cylinder for use in a jaw crusher in accordance with the present invention;

FIG. 5 is an isometric view of the sensor mounted in the adjustment device;

FIG. 6 is a side view of a jaw crusher in accordance with the present invention in which the adjustment device drive cylinder is shown;

FIG. 7 is a side cross section view of the maximum CSS distance between the fixed jaw and the moveable jaw of the jaw crusher in accordance with the present invention;

FIG. 8 is a side cross section view of the minimum CSS distance between the fixed jaw and the moveable jaw of the jaw crusher in accordance with the present invention;

FIG. 9 is a side cross section view of the fixed jaw and the moveable jaw of the jaw crusher in accordance with the present invention in a fully closed position;

FIG. 10 is an isometric view of the wedge and toggle beam in contact in a jaw crusher in accordance with the present invention;

FIG. 11 is an isometric view of the wedge and toggle beam not in contact in a jaw crusher in accordance with the present invention;

FIG. 12 is an isometric view of a control block comprising a pressure sensor in a jaw crusher in accordance with the present invention; and

FIG. 13 is a graph of CSS setting plotted against cylinder stroke for different wear values.

### DETAILED DESCRIPTION OF THE DRAWINGS

The present invention provides an apparatus and method for measuring and controlling the position of the moveable jaw of a jaw crusher with respect to the stationary jaw. This result is achieved by means of an adjustment device for adjusting the position of the moveable jaw relative to the stationary jaw. The adjustment device comprises a drive cylinder with an internally mounted sensor to measure the position of the moveable jaw relative to the stationary jaw.

In at least one embodiment of the present invention, there is provided an apparatus in which a sensor is integrated with the adjustment cylinder in order to detect the position of the moveable jaw. The detected position of the moveable jaw is compared with the actual position so as to adjust the CSS if necessary or desirable.

Typically, a jaw crusher will have two adjustment cylinders which control the position of respective wedges and which will be in communication with the sensor.

In addition, when in maintenance mode, the adjustment cylinders of at least one example of the apparatus in accordance with the present invention are drivable to urge the movable jaw against the stationary jaw to get a zero CSS position measurement. Measuring changes in the position at which the moveable jaw touches the stationary jaw provides an indication of wear. The adjustment cylinders are also provided with pressure sensors which are configured to detect physical contact between the moveable jaw and the stationary jaw which occurs at zero CSS.

These measurements can determine with high accuracy what the nominal CSS setting is, without the need for any external reference point. The sensors can also be calibrated to ensure accurate measurement over time.

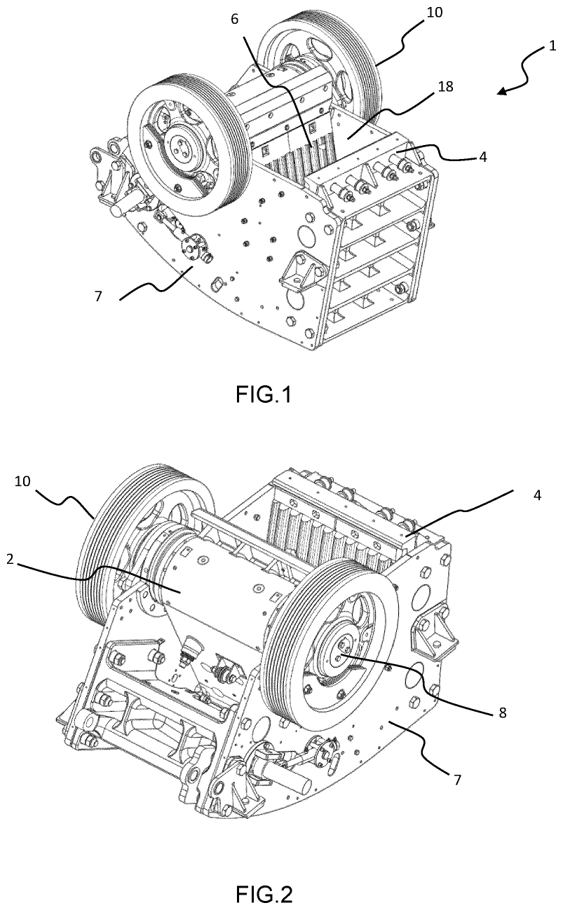

The following figures show an example of a jaw crusher with a positioning device and sensor in accordance with the present invention. The jaw crusher and various components thereof are described across FIGS. 1 to 12.

With particular reference to FIGS. 1, 2 and 7, the jaw crusher 1 comprises a movable jaw 2 and a stationary jaw 4 contained in a housing 7 and forming between them a variable crushing chamber 6 of the jaw crusher 1. The movable jaw 2 is driven by an eccentric jaw crusher shaft 8 which causes the movable jaw 2 to move back and forth, up and down relative to the stationary jaw 4.

The inertia required to crush material fed to the jaw crusher 1 is provided by a weighted flywheel 10 operable to move the eccentric jaw crusher shaft 8 on which the movable jaw 2 is mounted. A jaw crusher motor is operative for rotating the flywheel 10 by means of a transmission belt. The stationary jaw 4 is provided with a wear plate 16 and the movable jaw 2 is provided with a wear plate 14. The movement of the eccentric shaft 8 thus causes an eccentric motion of the movable jaw 2.

As shown in FIGS. 1, 7 and 8, material to be crushed is fed to an intake 18 for material to be crushed. The crushed material leaves the jaw crusher 1 via an outlet 20 for material that has been crushed. The jaws 2, 4 are farther apart at the material intake 18 than at the material outlet 20, forming a tapered crushing chamber 6 so that the material is crushed progressively to smaller and smaller sizes as the material travels downward towards the outlet 20, until the material is small enough to escape from the material outlet 20 at the bottom of the crushing chamber 6.

With particular reference to FIGS. 1, 7, 8 and 10, the position of the moveable jaw 2 with respect to the stationary jaw 4 is set by an adjustment mechanism. The adjustment mechanism often referred to as a toggle system, is configured for setting or adjusting the spacing between the lower ends of the moveable jaw 3 and of the stationary jaw 5 so that a predetermined maximum product size may be produced during the crush cycle.

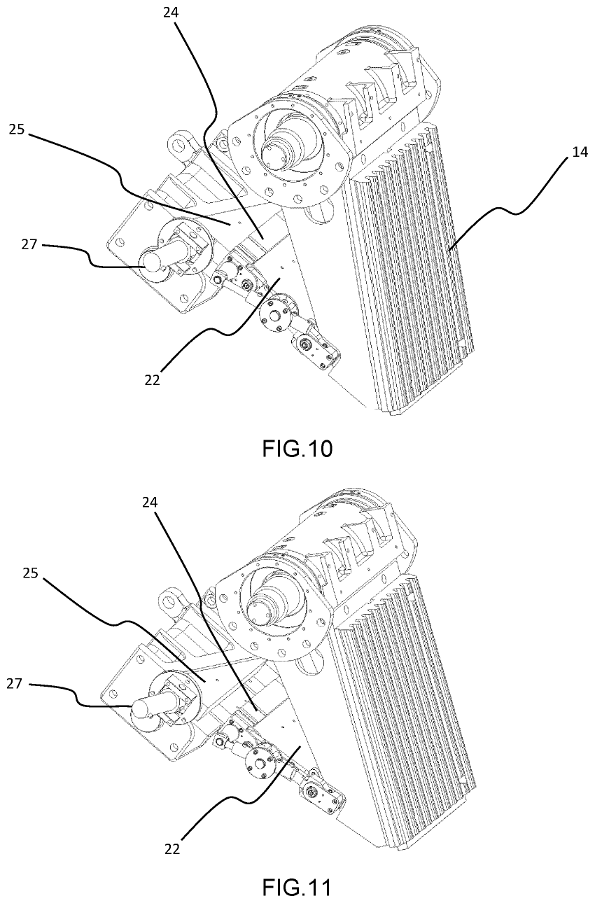

FIG. 3 is an isometric view of a toggle system for use in a jaw crusher in accordance with the present invention. In this embodiment the toggle system 33 comprises a toggle beam 24 which has a wedge 25 (see also FIG. 10) configured to be moved by a drive cylinder 27 (see also FIG. 10) in order to slide the wedge in and out in a transverse axis of the jaw crusher. The wedge 25 is moved by the hydraulic cylinder 27 to push a toggle beam 24 and thereby adjust the position of the moveable jaw 2 with respect to the stationary jaw 4.

Further to FIG. 3, the drive cylinder comprises a free end. In the exemplary embodiment of FIG. 3 and FIG. 4, this is made possible by providing a pivot on the cylinder 31 of the drive cylinder 25. The pivot being provided between the opposite ends of the drive cylinder 25. This configuration enables easy access to the sensor 37 when service or replacement is necessary.

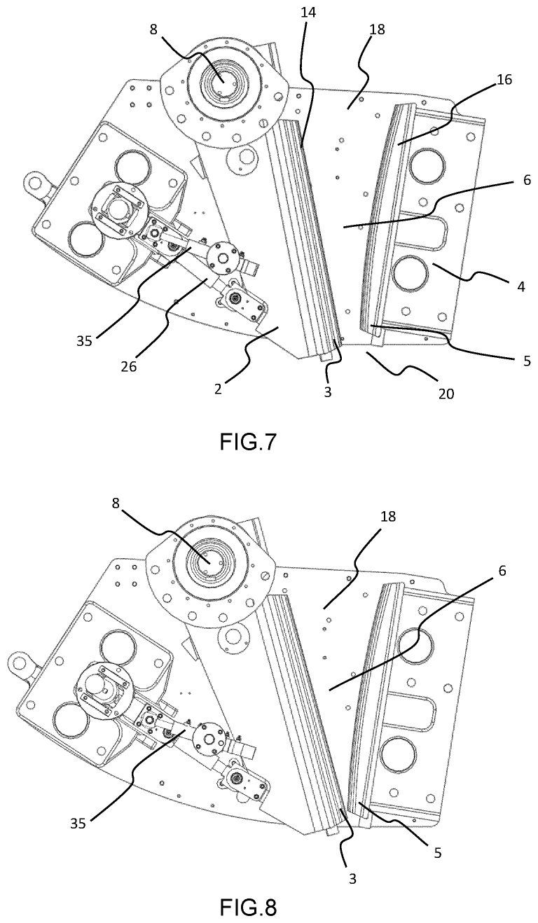

The hydraulic cylinder 27 is configured to move the wedge to increase or decrease its width thereby moving the toggle plate 22 (see also FIG. 10) and thus the moveable jaw 2 towards the stationary jaw and so change spacing between the jaws 2, 4 at the lower ends 3, 5 respectively, FIG. 7 shows a wider gap between lower ends 3, 5 and FIG. 8 shows a narrower gap.

Hydraulic cylinders 35 are configured to maintain pressure in the bore side of the cylinder to abut the toggle beam 24 to the wedge 25. This abutment is critical during operation as it transfers crushing load from the moving jaw 2 to the surrounding structure. Furthermore hydraulic cylinders 35 have a direct relationship regarding position with cylinder 27, meaning that the sensors 37 in FIG. 4, can communicate with the PLC to control actuation of cylinder 27 to set the CSS.

Toggle system 33 comprises a toggle plate 22, a toggle beam 24 and toggle clamping cylinders 26 connecting the toggle beam 24 to the movable jaw and configured to clamp the toggle plate 22 there between, i.e. configured to clamp the toggle plate to the movable jaw.

That is, the toggle beam 24, the toggle clamping cylinders 26 and the toggle plate 22 are arranged to pivot with the movable jaw, in particular about the crusher shaft 8

The toggle clamping cylinders 26 are connected directly to the toggle beam 24. The toggle clamping cylinders 25 are operative to urge the toggle beam 24 towards the movable jaw. Thereby the toggle plate is clamped to the movable jaw. The toggle plate may cooperate with a toggle seat provided on the movable jaw.

The toggle clamping cylinders 26 are pivotably mounted to the toggle beam 24, such as via a mounting bracket. The toggle clamping cylinder 26 are pivotable mounted to the movable jaw, such as via a mounting bracket as shown in FIG. 10 The toggle system 33 further comprises the drive cylinder 35 effective on the toggle beam 24, such as in a proximal direction and in a distal direction respectively, for adjusting the position of the moveable jaw 2 relative to the stationary jaw 4. The drive cylinder 35 is provided with an internally mounted sensor 37 to measure the position of the moveable jaw 2 relative to the stationary jaw 4.

The drive cylinder 35 is mounted to the crusher housing 7, in particular to an exterior side of the housing, and to the toggle beam 24. Thus the movable jaw may be displaced by expanding and contracting the drive cylinder 35.

Toggle clamping cylinder 26 maintains the pressure in the annulus side of the cylinder to clamp the toggle plate 22 (FIG. 10) to ensure the crushing force is transmitted from the moveable jaw 2.

FIG. 4 an isometric view of an adjustment device drive cylinder for use in a jaw crusher in accordance with the present invention.

The drive cylinder comprises a piston shaft 39 in a cylinder body 31 with a coupling 42. Transducer 37 is mounted centrally in the cylinder body 31 and measures position of the moveable jaw, which is adjustable relative to the stationary jaw.

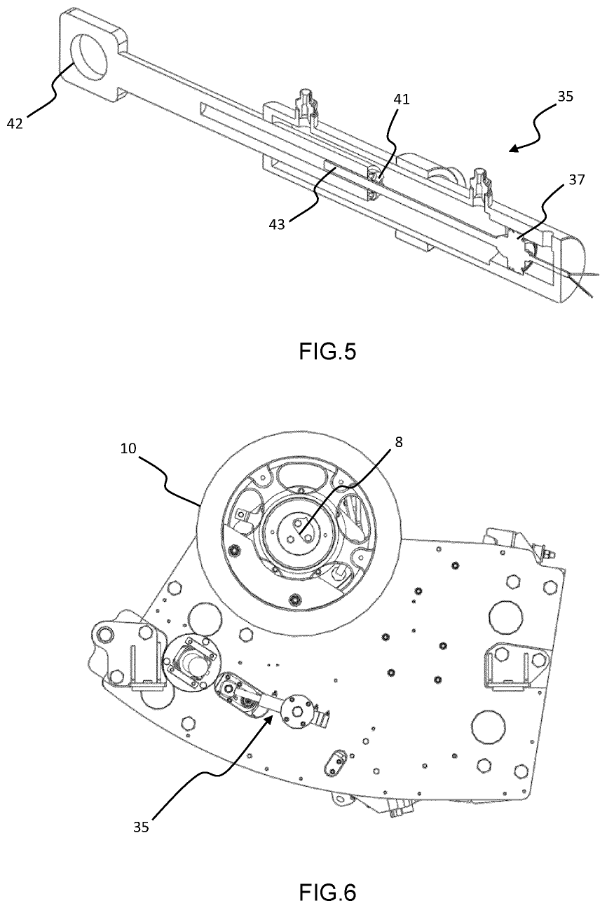

In this example of the present invention, and referring to FIGS. 5 and 6, the sensor 37 is mounted centrally in the cylinder 31 and comprises a linear displacement sensor which detects the cylinder rod/piston 39 position relative to the cylinder 31. In this example of the present invention, the linear displacement sensor 37 is a magneto strictive linear position sensor suitable for use in extreme environments rugged steal housing. It comprises a magnet 41 mounted on piston shaft 39, magnet position and hence stroke is detected with probe shaft 43. The magnetostrictive sensor is exceptionally shock resistant, extremely waterproofness, an operational temperature range of −40 to +85 deg C, a pressure resistance rated up to 1000 Bar, resolution to 1 micron and a suitable measurement length for the application.

The sensor 37 measures the cylinder extension/position and the signal from this sensor is used to derive the CSS via the machine programmable logic controller (PLC). The cylinder 35 position can also be set via the machine programmable logic controller PLC.

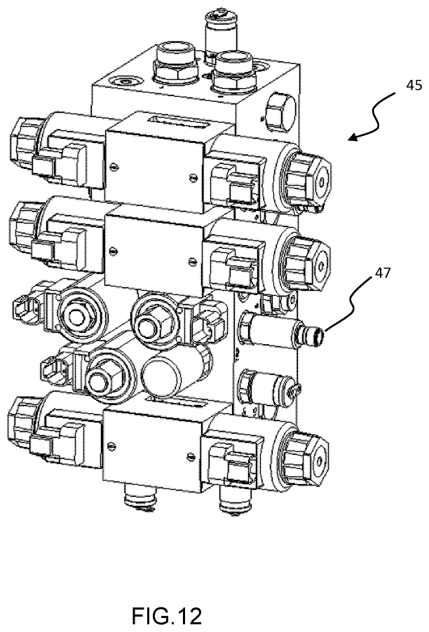

In addition to the linear displacement sensor 37, a pressure sensor 47 (see FIG. 12) is provided to detect external load on the moveable jaw. The pressure sensor is configured to detect contact between the moveable jaw and the stationary jaw. The pressure sensor assists with positioning of the moveable jaw with respect to the stationary jaw.

The cylinder 35 allows the moveable jaw to move through the entire range of CSS openings. Additionally, with the extra stroke length provided by the cylinder, additional wear measurement compensation is achieved. In this example, up to 50 mm of wear measurement compensation may be achieved.

FIGS. 7 to 11 show a range of CSS positions which are achievable using the apparatus of the present invention.

FIG. 7 is a side cross section view of the maximum CSS distance between the fixed jaw and the moveable jaw of the jaw crusher. It shows a jaw crusher 1 as previously described above and in which the distance between the lower end 3 of the moveable jaw 2 and the lower end 5 of the stationary jaw 4 is at its maximum extent.

FIG. 8 is a side cross section view of the minimum CSS distance between the fixed jaw and the moveable jaw of the jaw crusher when the jaw crusher is in use. It shows a jaw crusher 1 as previously described above and in which the distance between the lower end 3 of the moveable jaw 2 and the lower end 5 of the stationary jaw 4 is at its minimum extent.

As derivable from FIG. 7 and FIG. 8, the drive cylinder 35 has a line of action that is substantially aligned with the direction of movement of the movable jaw. Alternatively, or in addition, the drive cylinder 35 is arranged to extend substantially aligned with the tangent of a lower end portion of the movable jaw when the movable jaw is pivoted. This configuration facilitates improved accuracy in the calculation of CSS.

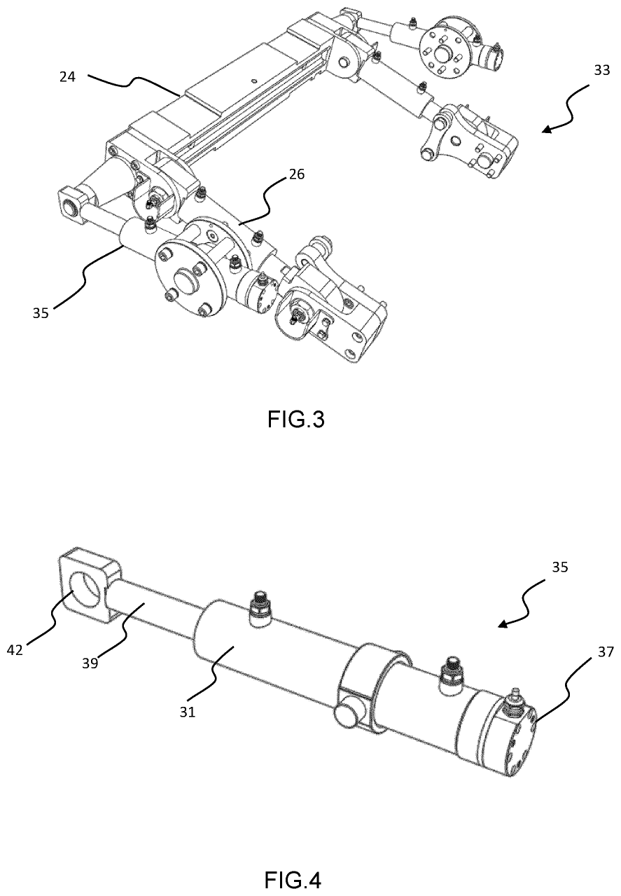

As is further derivable from FIG. 1 and FIG. 2, the drive cylinder 35 is arranged on an exterior side of the crusher housing 7. This configuration advantageously provides a level of protection to the drive cylinder 35 and the sensor 37, e.g. from dust and crushed material, whilst also enabling the access to the sensor 37 from the outside of the crusher housing 7.

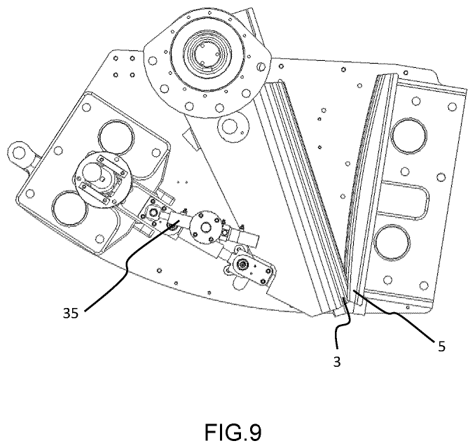

FIG. 9 is a side cross section view of the fixed jaw and the moveable jaw of the jaw crusher in accordance with the present invention in a fully closed position. It shows a jaw crusher 1 as previously described above and in which the lower end 3 of the moveable jaw 2 and the lower end 5 of the stationary jaw 4 overlap.

FIG. 10 is an isometric view of the toggle beam 24 and wedge 25 in contact in a jaw crusher in accordance with the present invention. It shows a jaw crusher 1 as previously described above along with the toggle plate 22. As shown, the toggle beam 24 is in contact with the wedge 25 and crushing forces are transferred from the moveable jaw 2.

FIG. 11 is an isometric view of the toggle beam 24 and wedge 25 not in contact in a jaw crusher in accordance with the present invention. It shows a jaw crusher 1 as previously described above along with the toggle plate 22. As shown, the toggle beam 24 is not in contact with wedge 25. This position allows wear measurement and CSS adjustment.

FIG. 12 is an isometric view of a control block 45 comprising a pressure sensor 47 in a jaw crusher in accordance with the present invention. When in maintenance/wear calibration mode, the adjustment cylinders are drivable to urge the movable jaw against the stationary jaw to get a zero CSS position measurement. Measuring changes in the position at which the moveable jaw touches the stationary jaw provides an indication of wear. The pressure sensor 47 is configured to detect physical contact between the moveable jaw and the stationary jaw which occurs at zero CSS.

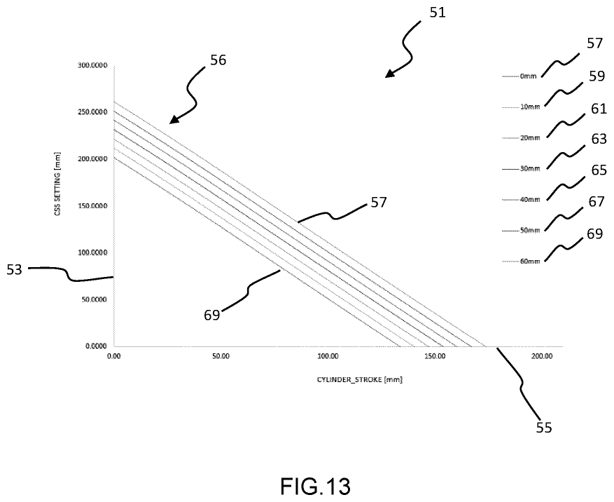

FIG. 13 is a graph 51 which plots CSS setting 53 against cylinder stroke 55 and shows a family of curves 56 for wear values of 0 mm 57, 10 mm 59, 20 mm 61, 30 mm 63, 40 mm 65, 50 mm 67 and 60 mm 69. FIG. 13 provides an example of the type of calibration graph which may be used to calculate wear.

In another example of the present invention, a wear compensation sub routine is built into system logic in order to measure wear on the jaw wear plates. Wear of the plate, also referred to as a jaw liner, inherently increases the gap setting as material is removed from the crushing zone.

The amount of wear may be automatically determined by recording the position on one or each linear transducer when metal to metal contact has occurred (Zero CSS). The distance between the moveable jaw and the stationary jaw can be set to compensate for the wear in the jaw wear plates before the user specifies a final size of product.

Further to this, the logic is built so that the system can predict wear rates for the users specific application and automatically give the user updates as to when the wear liners need replacing or turning (Wear Prediction). The set points in the logic are directly related to the liner type selected within the PLC.

Wear calibration is conducted periodically, from this, each wear measurement will be stored within the machine PLC. Plotting this against crushing hours which is also stored will give a wear rate of liners within their current application. Using a few other parameters such as engine load/motor power consumption and product output (TPH), an estimation of the lifespan of the wear plates under predefined conditions may be obtained. The wear life given in time will be presented to the customer and allow them to order replacement liners at the correct time.

The invention is not limited to the embodiments hereinbefore described but may be varied in both construction and detail.

### ITEMS

Item 1. A jaw crusher 1 comprising:
a crusher housing 7 having an inlet 18 for material to be crushed, an outlet 20 for material that has been crushed,
a moveable jaw 2, provided with a wear plate 14 and a stationary jaw 4, provided with a second wear plate 16, the moveable jaw 2 and the stationary jaw 4 forming between them a crushing chamber 6, the moveable jaw 2 being coupled to an eccentric jaw crusher shaft 8 which causes the moveable jaw to reciprocate in an eccentric motion to crush the material between the moveable jaw 2 and the stationary jaw 4, and
a toggle system 33 comprising a toggle plate 22, a toggle beam 24 and toggle clamping cylinders 26 connecting the toggle beam 24 to the movable jaw and configured to clamp the toggle plate 22 there between, wherein the toggle system 33 further comprises a drive cylinder 35 effective on the toggle beam 24 for adjusting the position of the moveable jaw 2 relative to the stationary jaw 4, wherein the drive cylinder 35 is provided with an internally mounted sensor to measure the position of the moveable jaw 2 relative to the stationary jaw 4.

Item 2. The jaw crusher as in item 1, wherein the drive cylinder 35 is a hydraulic drive cylinder.

Item 3. The jaw crusher as in item 1 or item 2, wherein the internally mounted sensor 37 is centrally mounted in the drive cylinder.

Item 4. The jaw crusher as in any preceding item, wherein the internally mounted sensor is a magnetostrictive linear position sensor.

Item 5. The jaw crusher as in any preceding item, wherein the internally mounted sensor measures stroke distance of the drive cylinder.

Item 6. The jaw crusher as in item 5, wherein measurement of the stroke distance provides a linear distance between the moveable jaw and the stationary jaw.

Item 7. The jaw crusher as in item 5 or item 6, wherein measurement of the stroke distance provides a measure of total wear on the moveable jaw wear plate 14 and fixed jaw wear plate 16.

Item 8. The jaw crusher as in items 5 to 7, wherein the stroke distance is constantly measured by the internally mounted sensor.

Item 9. The jaw crusher as in any preceding item, wherein the drive cylinder is driven to urge the moveable jaw 2 and hence moveable jaw wear plate 14 into contact with the fixed jaw wear plate 16 to calibrate the distance measured by the internally mounted sensor by obtaining a zero CSS position.

Item 10. The jaw crusher as in any preceding item, further comprising a control block 45 with a pressure sensor 47 configured to detect contact between the moveable jaw wear plate 14 and the fixed jaw wear plate 16.

Item 11. The crusher according to any one of the preceding items 7 to 10, further configured to store values of said wear measurement and to store values of crushing hours, and to calculate a wear rate of the wear plates based on said stored values.

Item 12. The crusher according to any one of the preceding items 7 to 11, further configured to calculate an estimate the lifespan of the wear plates based on said wear rate.

Item 13. A method for adjusting a jaw crusher, the jaw crusher comprising:
a crusher housing 7 having an inlet 18 for material to be crushed, an outlet 20 for material that has been crushed,
a moveable jaw 2, provided with a wear plate 14 and a stationary jaw 4, provided with a second wear plate 16, the moveable jaw 2 and the stationary jaw 4 forming between them a crushing chamber 6, the moveable jaw 2 being coupled to an eccentric jaw crusher shaft 8 which causes the moveable jaw to reciprocate in an eccentric motion to crush the material between the moveable jaw 2 and the stationary jaw 4, and
a toggle system 33 comprising a toggle plate 22, a toggle beam 24 and toggle clamping cylinders 26 connecting the toggle beam 24 to the movable jaw and configured to clamp the toggle plate 22 there between, wherein the toggle system 33 further comprises a drive cylinder 35 effective on the toggle beam 24 for adjusting the position of the moveable jaw 2 relative to the stationary jaw 4, wherein the drive cylinder 35 is provided with an internally mounted sensor to measure the position of the moveable jaw 2 relative to the stationary jaw 4, the method comprising;
moving, by means of the drive cylinder 35 the moveable jaw into a position at or near the stationary jaw,
measuring the stroke of the drive cylinder 35 using the sensor 37 to calculate the position of the moveable jaw relative to the stationary jaw.

Item 14. The method as in item 13, wherein measurement of the stroke distance provides a measure of total wear on the moveable jaw wear plate 14 and fixed jaw wear plate 16.

Item 15. The method as in any of items 13 or 14, wherein measurement of the stroke distance is used to set the position of the moveable jaw with respect to the stationary jaw.

Item 16. The method as in any of items 13 to 15, wherein a pressure sensor 47 is configured to detect contact between the moveable jaw and the stationary jaw.

Item 17. The method as in any one of items 13 to 16, wherein the drive cylinder urges the moveable jaw 2 and hence moveable jaw wear plate 14 into contact with the fixed jaw wear plate 16 to calibrate the distance measured by the internally mounted sensor by obtaining a zero CSS position.

1. A jaw crusher comprising:
a crusher housing having an inlet for material to be crushed, an outlet for material that has been crushed, a moveable jaw provided with a wear plate, and a stationary jaw, provided with a second wear plate, the moveable jaw and the stationary jaw forming between them a crushing chamber, the moveable jaw being coupled to an eccentric jaw crusher shaft which causes the moveable jaw to reciprocate in an eccentric motion to crush the material between the moveable jaw and the stationary jaw; and
a toggle system including a toggle plate, a toggle beam and toggle clamping cylinders connected to the toggle beam to clamp the toggle plate, wherein the toggle system further includes a drive cylinder effective on the toggle beam for adjusting the position of the moveable jaw relative to the stationary jaw, wherein the drive cylinder is provided with an internally mounted sensor arranged to measure a position of the moveable jaw relative to the stationary jaw.

2. The jaw crusher as claimed in claim 1, wherein the drive cylinder is a hydraulic drive cylinder.

3. The jaw crusher as claimed in claim 1, wherein the internally mounted sensor is centrally mounted in the drive cylinder.

4. The jaw crusher as claimed in claim 1, wherein the internally mounted sensor is a magnetostrictive linear position sensor.

5. The jaw crusher as claimed in claim 1, wherein the internally mounted sensor measures stroke distance of the drive cylinder.

6. The jaw crusher as claimed in claim 5, wherein measurement of the stroke distance provides a linear distance between the moveable jaw and the stationary jaw.

7. The jaw crusher as claimed in claim 5, wherein measurement of the stroke distance provides a measure of total wear on the moveable jaw wear plate and fixed jaw wear plate.

8. The jaw crusher as claimed in claim 5 , wherein the stroke distance is constantly measured by the internally mounted sensor.

9. The jaw crusher as claimed in claim 1, wherein the drive cylinder is driven to urge the moveable jaw and hence the moveable jaw wear plate into contact with the fixed jaw wear plate to calibrate the distance measured by the internally mounted sensor by obtaining a zero CSS position.

10. The jaw crusher as claimed in claim 1, further comprising a control block with a pressure sensor configured to detect contact between the moveable jaw wear plate and the fixed jaw wear plate.

11. The crusher according to claim 7, further configured to store values of said wear measurement and to store values of crushing hours, and to calculate a wear rate of the wear plates based on said stored values.

12. The crusher according to claim 11, further configured to calculate an estimate of a lifespan of the wear plates based on said wear rate.

13. A method for adjusting a jaw crusher, the jaw crusher comprising:
a crusher housing having an inlet for material to be crushed, an outlet for material that has been crushed;
a moveable jaw provided with a wear plate;
a stationary jaw provided with a second wear plate, the moveable jaw and the stationary jaw forming between them a crushing chamber, the moveable jaw being coupled to an eccentric jaw crusher shaft which causes the moveable jaw to reciprocate in an eccentric motion to crush the material between the moveable jaw and the stationary jaw; and
a toggle system including a toggle plate, a toggle beam and toggle clamping cylinders connected to the toggle beam to clamp the toggle plate, wherein the toggle system further includes a drive cylinder effective on the toggle beam for adjusting the position of the moveable jaw relative to the stationary jaw, wherein the drive cylinder is provided with an internally mounted sensor to measure the position of the moveable jaw relative to the stationary jaw,
the method comprising;
moving, by means of the drive cylinder the moveable jaw into a position at or near the stationary jaw; and
measuring a stroke of the drive cylinder using the sensor to calculate the position of the moveable jaw relative to the stationary jaw.

14. The method as claimed in claim 13, wherein measurement of the stroke distance provides a measure of total wear on the moveable jaw wear plate and fixed jaw wear plate.

15. The method as claimed in claim 13, wherein measurement of the stroke distance is used to set the position of the moveable jaw with respect to the stationary jaw.

16. The method as claimed in claim 13, wherein a pressure sensor is configured to detect contact between the moveable jaw and the stationary jaw.

17. The method as claimed in claim 13, wherein the drive cylinder urges the moveable jaw and hence moveable jaw wear plate into contact with the fixed jaw wear plate to calibrate the distance measured by the internally mounted sensor by obtaining a zero CSS position.

18. The method according to claim 14, further comprising storing values of said wear measurement; storing crushing hours; calculating a wear rate of the wear plates based on said stored values.

19. The method according to claim 18, further comprising calculating an estimate lifespan of the wear plates based on said wear rate.
